(19) United States
(12) Patent Application Publication
(10) Pub. No.: US 2021/0403035 A1
(43) Pub. Date: Dec. 30, 2021

(54) SYSTEMS AND METHODS FOR AUTONOMOUS VEHICLE PERFORMANCE EVALUATION

(71) Applicant: Woven Planet North America, Inc., Los Altos, CA (US)

(72) Inventors: Emilie Jeanne Anne Danna, Sunnyvale, CA (US); Erik Newell Gaasedelen, Palo Alto, CA (US); Tara Hashemi Sadraei, San Francisco, CA (US)

(73) Assignee: Woven Planet North America, Inc., Los Altos, CA (US)

(21) Appl. No.: 16/917,245

(22) Filed: Jun. 30, 2020

(51) Int. Cl. B60W 60/00; G01S 19/42; B60W 30/095

(52) U.S. Cl. CPC B60W 60/0011; G01S 19/42; B60W 2420/42; B60W 2420/52; B60W 30/095

(57) ABSTRACT

Systems, methods, and non-transitory computer-readable media can determine mission data associated with a scenario encountered during operation of a vehicle. A first evaluation of the scenario can be determined by evaluating the mission data using a simulation behavior model based on simulated driving data. A second evaluation of the scenario can be determined by evaluating the mission data using an observed behavior model based on observed driving data. Vehicle performance of an autonomy system of the vehicle can be evaluated based on the first evaluation and the second evaluation.

### FIELD OF THE INVENTION

The present technology relates to autonomous vehicle systems. More particularly, the present technology relates to autonomous vehicle performance evaluation.

### BACKGROUND

Vehicles are increasingly being equipped with intelligent features that allow them to monitor their surroundings and make informed decisions on how to react. Such vehicles, whether autonomously, semi-autonomously, or manually driven, may be capable of sensing their environment and navigating with little or no human input as appropriate. The vehicle may include a variety of systems and subsystems for enabling the vehicle to determine its surroundings so that it may safely navigate to target destinations or assist a human driver, if one is present, with doing the same. As one example, the vehicle may have a computing system (e.g., one or more central processing units, graphical processing units, memory, storage, etc.) for controlling various operations of the vehicle, such as driving and navigating. To that end, the computing system may process data from one or more sensors. For example, a vehicle may have sensors that can recognize hazards, roads, lane markings, traffic signals, and the like. Data from sensors may be used to, for example, safely drive the vehicle, activate certain safety features (e.g., automatic braking), and generate alerts about potential hazards.

### SUMMARY

Various embodiments of the present technology can include systems, methods, and non-transitory computer readable media configured to determine mission data associated with a scenario encountered during operation of a vehicle. A first evaluation of the scenario can be determined by evaluating the mission data using a simulation behavior model based on simulated driving data. A second evaluation of the scenario can be determined by evaluating the mission data using an observed behavior model based on observed driving data. Vehicle performance of an autonomy system of the vehicle can be evaluated based on the first evaluation and the second evaluation.

In an embodiment, the first evaluation is associated with a first weight and the second evaluation is associated with a second weight and the evaluating is further based on the first weight applied to the first evaluation and the second weight applied to the second evaluation.

In an embodiment, the first weight indicates a first reliance associated with the simulation behavior model for a type of evaluation being performed by the simulation behavior model and the second weight indicates a second reliance associated with the observed behavior model for the type of evaluation being performed by the observed behavior model.

In an embodiment, the first weight is based on a plurality of evaluations by the simulation behavior model based on other mission data different from the mission data associated with the scenario and the second weight is based on a plurality of evaluations by the observed behavior model based on the other mission data.

In an embodiment, a false positive or a false negative associated with at least one of: the first evaluation or the second evaluation is identified.

In an embodiment, the mission data is partitioned into a plurality of mission chunks.

In an embodiment, at least one of the simulation behavior model or the observed behavior model applies at least one of: a rule based assumption or a model based assumption.

In an embodiment, at least one of the first evaluation or the second evaluation includes a determination of a predicted contact between the vehicle and an object associated with the scenario.

In an embodiment, the evaluating the autonomous vehicle performance of the autonomy system comprises determining a performance metric that includes at least one of: miles per estimated contact (MPEC) or miles per intervention (MPI).

In an embodiment, the mission data is collected by one or more sensors on the autonomous vehicle, and the mission data includes at least one of: image data, video data, light detection and ranging (LiDAR) data, radar data, or global positioning system (GPS) data.

### BRIEF DESCRIPTION OF THE DRAWINGS

FIGS. 1A-1C illustrate example scenarios demonstrating various challenges that may be experienced in conventional approaches to autonomous vehicle (AV) performance evaluation.

FIG. 2 illustrates an example environment including an AV performance evaluation module, according to an embodiment of the present technology.

FIGS. 3A-3B illustrate example applications of AV performance evaluation, according to an embodiment of the present technology.

FIGS. 4A-4B illustrate example scenarios associated with various chunks of a mission, according to an embodiment of the present technology.

FIGS. 5A-5B illustrate example methods, according to an embodiment of the present technology.

FIG. 6 illustrates an example block diagram of a transportation management environment, according to an embodiment of the present technology.

FIG. 7 illustrates an example of a computer system or computing device that can be utilized in various scenarios, according to an embodiment of the present technology.

The figures depict various embodiments of the present technology for purposes of illustration only, wherein the figures use like reference numerals to identify like elements. One skilled in the art will readily recognize from the following discussion that alternative embodiments of the structures and methods illustrated in the figures can be employed without departing from the principles of the present technology described herein.

### DETAILED DESCRIPTION

Vehicles are increasingly being equipped with intelligent features that allow them to monitor their surroundings and make informed decisions on how to react. Such vehicles, whether autonomously, semi-autonomously, or manually driven, may be capable of sensing their environment and navigating with little or no human input. The vehicle may include a variety of systems and subsystems for enabling the vehicle to determine its surroundings so that it may safely navigate to target destinations or assist a human driver, if one is present, with doing the same. As one example, the vehicle may have a computing system for controlling various operations of the vehicle, such as driving and navigating. To that end, the computing system may process data from one or more sensors. For example, a vehicle may have one or more sensors or sensor systems that can recognize hazards, roads, lane markings, traffic signals, etc. Data from sensors may be used to, for example, safely drive the vehicle, activate certain safety features (e.g., automatic braking), and generate alerts about potential hazards.

Safety is an important aspect in measuring autonomous vehicle performance. Various conventional approaches attempt to measure safety and other aspects of autonomous vehicle performance based on miles per intervention (MPI). MPI, as its name suggests, is a measure of an average number of miles traveled by an autonomous vehicle before an intervention. The intervention can occur when an autonomy system controlling the autonomous vehicle disengages (e.g., a “disengagement”) or a driver intervenes with the autonomy system and disengages it (e.g., a “driver intervention”). While various conventional approaches rely on MPI, MPI can be a poor measure of autonomous vehicle performance because MPI is weakly and inconsistently correlated with actual performance. For example, a disengagement or a driver intervention does not necessarily indicate that a collision or other undesirable result would have occurred had the disengagement or driver intervention not occurred. Further, MPI is often misleading. For example, when an autonomous vehicle navigates a well-known road, the autonomous vehicle may achieve an artificially high MPI. In contrast, when the same autonomous vehicle navigates a new environment that is relatively less known, the autonomous vehicle may earn a relatively low MPI. Thus, conventional approaches that rely on MPI can fail to accurately measure autonomous vehicle performance.

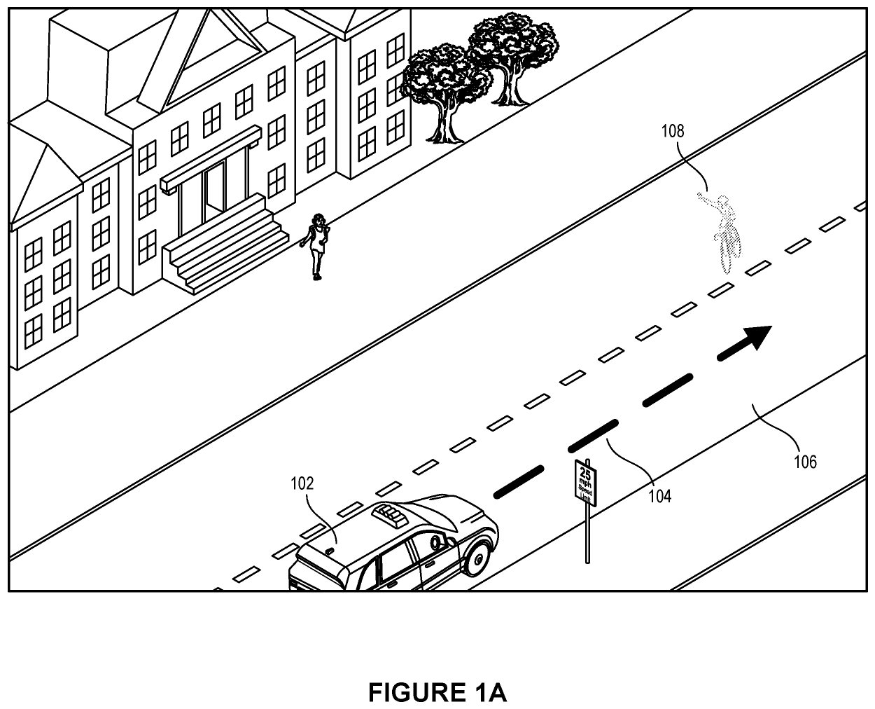

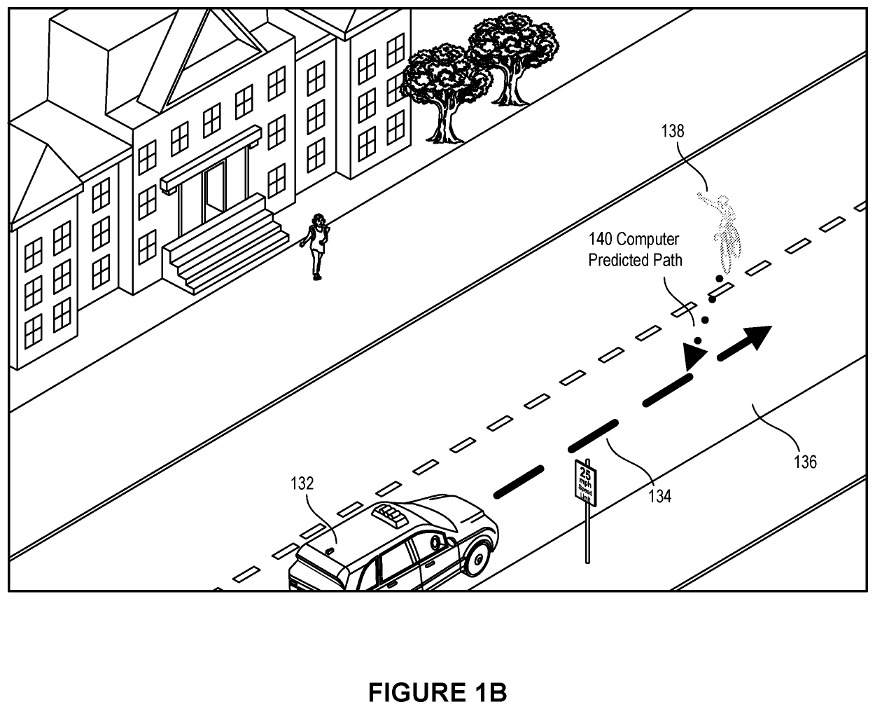

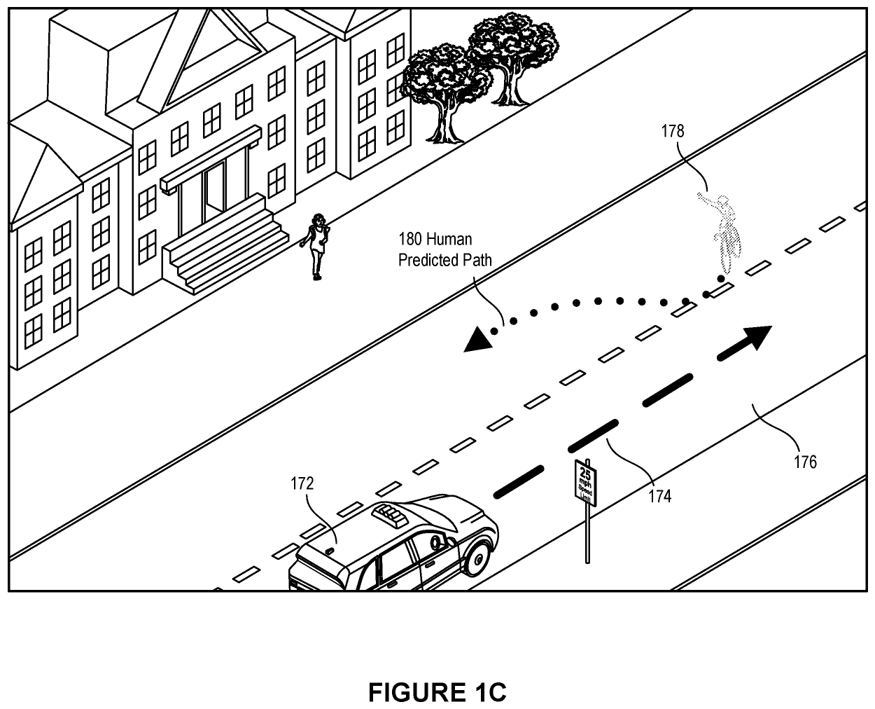

Another measure of autonomous vehicle performance is miles per estimated contact (MPEC). MPEC is a measure of an average number of miles traveled by an autonomous vehicle before an estimated contact. The estimated contact is based on a determination of whether a collision or a contact would occur if an autonomy system controlling an autonomous vehicle does not disengage or a driver does not intervene in the autonomy system. This determination of estimated contact can present various challenges. For example, FIG. 1A illustrates an example scenario that demonstrates some of the various challenges involved with determining estimated contact. In the example scenario, an autonomous vehicle 102 with a driver is navigating a road segment 106 in a planned direction 104. The autonomous vehicle 102 encounters an object 108 on the road segment 106. As shown, the object 108 is a cyclist. However, the object 108 could be any other type of object or condition. In response to the object 108, an autonomy system controlling the autonomous vehicle 102 or the driver may disengage. The autonomy system or the driver may disengage the autonomous vehicle 102 because, for example, the autonomy system failed to detect the object 108, or the planned direction 104 indicates the autonomy system failed to properly consider the object 108. In this example, it is possible that had the autonomy system or the driver not disengaged the autonomous vehicle 102, the autonomous vehicle 102 would have had a collision with the object 108. It is also possible that the autonomous vehicle 102 would not have had the collision with the object 108 even if the autonomy system or the driver did not disengage the autonomous vehicle 102. However, because the autonomy system or the driver disengaged the autonomous vehicle 102, whether the collision would have occurred is not certain. Thus, a reliable and accurate determination of whether a collision would have occurred is important for using MPEC as a reliable measure of autonomous vehicle performance.

FIGS. 1B and 1C illustrate example scenarios generated by different models. In FIG. 1B, an example simulated behavior model may be configured to predict object paths. The example simulated behavior model, when provided with the scenario described in FIG. 1A, predicts that the autonomous vehicle 132 continues in a linear path 134 on the road segment 136. The example simulated behavior model also predicts that the cyclist 138 continues in a linear path 140. Based on the predictions from the example simulated behavior model, it may be determined that a collision would have occurred if the autonomy system or the driver did not disengage the autonomous vehicle 132. In FIG. 1C, an example observed behavior model may be configured to predict how objects behave based on observed behaviors from similar scenarios. The example observed behavior model, when provided with the scenario described in FIG. 1A, predicts that the autonomous vehicle 172 continues in its planned direction 174 on the road segment 176. The example observed behavior model also predicts that the cyclist 178 will travel a predicted path 180 based on observed behaviors of prior objects in similar scenarios. Based on the predictions from the observed behavior model, it may be determined that a collision would not have occurred if the autonomy system or the driver did not disengage the autonomous vehicle 172. As demonstrated in FIGS. 1B and 1C, different models may generate different predictions, which may result in different evaluations of autonomous vehicle performance.

An improved approach in accordance with the present technology provides for improved evaluation of autonomous vehicle performance. In various embodiments, evaluation of autonomous vehicle performance can be based on a determination of estimated events, such as estimated contact. In general, the present technology determines mission data associated with a scenario encountered by an autonomy system during operation of an autonomous vehicle. The mission data can include, for example, sensor data collected by various sensors on the autonomous vehicle during operation of the autonomous vehicle. A first evaluation of the scenario can be determined by a first model. The first model can be, for example, a simulation behavior model that predicts events based on simulated driving data. A second evaluation of the scenario can be determined by a second model. The second model can be, for example, an observed behavior model that predicts events based on observed driving data. Autonomous vehicle performance of the autonomy system can be evaluated based on the first evaluation and the second evaluation. Evaluating autonomous vehicle performance based on a first evaluation of a disengagement as determined by, for example, a simulation behavior model and a second evaluation of the disengagement as determined by, for example, an observed behavior model provides several improvements. For example, an evaluation of autonomous vehicle performance based on the first evaluation by the simulation behavior model and the second evaluation by the observed behavior model produces more consistent and accurate results than an evaluation based solely on either model. More accurate determinations about whether an undesirable event would have occurred had an autonomy system of an autonomous vehicle not been disengaged allow for more accurate determinations of vehicle performance and accordingly inform more optimal assignments of autonomous vehicles to the field for operation. More details relating to the present technology are provided below.

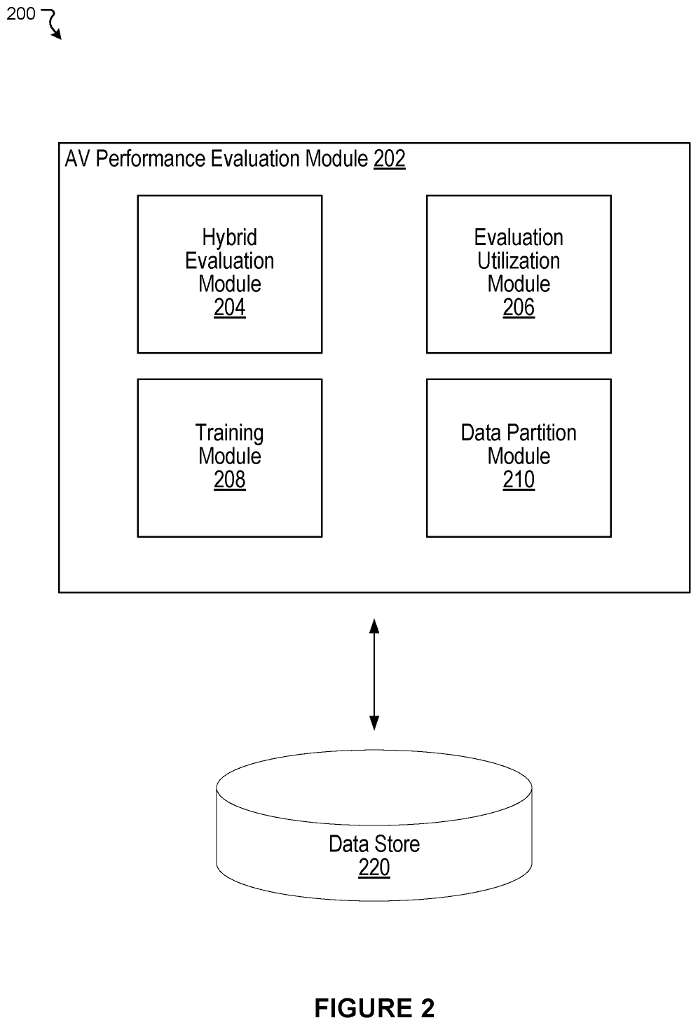

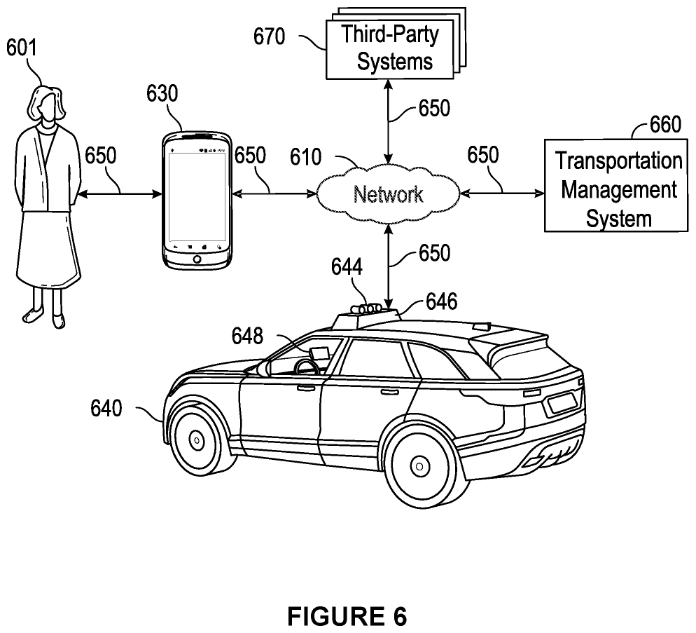

FIG. 2 illustrates an example system 200 including an example AV performance evaluation module 202, according to an embodiment of the present technology. As shown, the AV performance evaluation module 202 can include a hybrid evaluation module 204, an evaluation utilization module 206, a training module 208, and a data partition module 210. In various embodiments, the AV performance evaluation module 202 has access to sensor data collected by sensors of a fleet of vehicles from various sources and geographic locations. Sensor data may be collected by, for example, sensors mounted to the vehicles themselves and/or sensors on computing devices associated with users riding within the fleet of vehicles (e.g., user mobile devices). For example, the AV performance evaluation module 202 can be configured to communicate and operate with at least one data store 220 that is accessible to the AV performance evaluation module 202. The at least one data store 220 can be configured to store and maintain various types of data, such as sensor data captured by the fleet of vehicles, disengagement information, and the like. In some embodiments, some or all data stored in the data store 220 can be stored by the vehicle 640 of FIG. 6. In some embodiments, some or all of the functionality performed by the AV performance evaluation module 202 and its sub-modules may be performed by one or more computing systems implemented in a vehicle, such as the vehicle 640 of FIG. 6. In some embodiments, some or all of the functionality performed by the AV performance evaluation module 202 and its sub-modules may be performed by one or more computing systems associated with (e.g., carried by) one or more users riding in a vehicle and/or participating in a ridesharing service, such as the computing device 630 of FIG. 6. In some embodiments, some or all of the functionality performed by the AV performance evaluation module 202 and its sub-modules may be performed by one or more backend computing systems, such as a transportation management system 660 of FIG. 6. The components (e.g., modules, elements, etc.) shown in this figure and all figures herein are exemplary only, and other implementations may include additional, fewer, integrated, or different components. Some components may not be shown so as not to obscure relevant details. While discussion provided herein may reference autonomous vehicles as examples, the present technology can apply to any other type of vehicle, such as semi-autonomous vehicles.

In FIG. 2, the hybrid evaluation module 204 can be configured to apply a hybrid evaluation framework to evaluate a mission chunk based on models to determine whether an event would have occurred. As further described herein, the mission chunk can be a portion of data associated with a mission. The hybrid evaluation module 204 can generate computer simulation models (e.g., computer simulation behavior models) and support human models (e.g., observed human behavior models) to evaluate the mission chunk. The computer simulation model may be based on data obtained from running simulations of different scenarios. In contrast to the human model, the computer simulation model may be based on data obtained from running computer simulations. In a computer simulation model, detected sensor data (e.g., image data, video data, LiDAR data, radar data, GPS data, etc.) associated with a mission chunk is provided to the computer simulation model. The mission chunk may be associated with a simulated mission run by a simulation. The computer simulation model runs simulations of predictions of events to determine a scenario associated with the mission chunk and models behavior of an autonomous vehicle in response to the scenario. In some cases, a mission chunk is associated with a disengagement. In these cases, a computer simulation model can simulate behavior of an autonomy system of an autonomous vehicle in response to a scenario associated with the mission chunk without disengaging the autonomy system of the autonomous vehicle. In order to simulate what would likely have occurred if the autonomy system of the autonomous vehicle did not disengage, the computer simulation model can adopt various rule based or model based assumptions. As an example of a rule based assumption, the computer simulation model can assume that all external objects (e.g., dynamic objects other than the autonomous vehicle) would continue whatever behavior they had prior to the disengagement. For example, the computer simulation model can assume that all external vehicles would continue on the same trajectory (e.g., direction, speed, acceleration, etc.) they had prior to the disengagement. As an example of a model based assumption, the simulation model can assume that external objects would behave in accordance with models corresponding to the external objects. For example, the simulation model can assume that all external vehicles would behave in accordance with a vehicle behavioral model and accordingly react to the autonomous vehicle. By simulating the behavior of the autonomy system of the autonomous vehicle without disengagement and simulating the behavior of external objects, the simulation model can determine whether an event, such as the autonomous vehicle contacting one of the external objects, would occur.

In a human model, predictions of events to determine a scenario associated with a mission chunk are based on observations from how human drivers behave in similar events. In some examples, the human model is based on observations (e.g., observed sensor data) of how humans drive in similar events. Observed sensor data may include image data, video data, LiDAR data, radar data, GPS data, etc. Observations of how humans behaved in similar events may be applied to determine an outcome of an event. In some cases, sensor data associated with a mission chunk is provided to a human evaluator. The mission chunk may be associated with a disengagement of an autonomy system of an autonomous vehicle. The human evaluator, based on the sensor data, can make a determination of whether an event would have occurred if the autonomy system of the autonomous vehicle had not disengaged. The human evaluator may be provided with various rules or guidelines with which they must comply in making the determination. For example, the human evaluators may be instructed to assume that all external objects would continue whatever behavior they had prior to the disengagement.

Both computer simulation models and human models are associated with their respective advantages and disadvantages with regard to their evaluation of mission chunks. Computer simulation models can be advantageous over human models in that computer simulation models tend to be faster, more efficient, and more consistent. However, computer simulation models may be inaccurate due to a lack of collected, observed driving data for particular scenarios (e.g., edge-case scenarios) and may be prone to false positives. For example, a computer simulation model, in evaluating a disengagement of an autonomy system of an autonomous vehicle, may be provided with certain rule based assumptions that do not completely or accurately describe how external objects would act. Based on these rule based assumptions, the computer simulation model may mistakenly make a determination that an event would have occurred if the autonomy system of the autonomous vehicle did not disengage. Human models can be advantageous over simulation models in that human evaluators tend to have a more intuitive understanding of how external objects would act. However, human models can be slower and inconsistent. Different human evaluators tend to have their own subjective assumptions that inconsistently skew their evaluations. Further, human models may be prone to false negatives. For example, a human evaluator, in evaluating a disengagement of an autonomy system of an autonomous vehicle, may be more likely to assume that external objects would avoid the autonomous vehicle. Even if provided with rules or guidelines with which the human evaluator must comply, the human evaluator may not be completely removed of subjective assumptions or judgment. Although both of the computer simulation model and the human model may be prone to false negatives and/or positives when used in isolation, when evaluating a scenario using a hybrid evaluation model (i.e., combined computer simulation model and human model), the hybrid evaluation model performs significantly better than either model in isolation in providing a more accurate evaluation of the scenario.

The hybrid evaluation module 204 applies a hybrid evaluation framework to provide improved evaluation of mission chunks based on a combination of multiple models. The hybrid evaluation module 204 can evaluate a mission chunk based on multiple models. The models, which can include computer simulation models and human models, can evaluate the mission chunk under different rule based assumptions, model based assumptions, rules, and guidelines. The evaluations can be weighted, and an overall evaluation of autonomous vehicle performance can be generated based on the weighted evaluations. The weights can be determined based on the models and on the type of evaluation being performed. Certain models may be more accurate and consistent than other models at determining whether a certain type of contact would occur under certain conditions. These certain models may be associated with a higher weight in an evaluation of autonomous vehicle performance for the certain type of contact or certain type of conditions. For example, an evaluation of autonomous vehicle performance can be performed based on MPEC, an average number of miles per estimated contact. Mission chunks associated with missions conducted by autonomous vehicles controlled by an autonomy system can be provided to different models. The mission chunks associated with disengagements of the autonomous vehicles can be provided to the models. For each mission chunk associated with a disengagement, each model can make a determination of whether contact would have occurred had the autonomous vehicle not disengaged. Each model can produce a score reflective of their respective determination and a confidence level regarding the correctness of the determination. The scores can be weighted based on the models that produced the scores. The models that are associated with higher accuracy when determining whether contact would have occurred can be weighted higher than models that are associated with lower accuracy when determining whether contact would have occurred. An MPEC score for the autonomy system can be determined based on the weighted scores.

Weights can indicate importance or reliance on an output of a model. Weights can be expressed as percentages or values that are indicative of a certain probability distribution. Weights associated with models and the models themselves can be refined over time. Mission chunks that are not associated with disengagements of autonomous vehicles can be provided to the models. The models can evaluate the mission chunks that are not associated with disengagements, and the weights associated with the models can be refined based on how the models evaluated the mission chunks. If a model makes a determination that an event, such as a collision or a contact, would have occurred when provided with a mission chunk that is not associated with a disengagement, a weight associated with the model can be lowered. If a model makes a determination that an event would not have occurred when provided with a mission chunk that is not associated with a disengagement, a weight associated with the model can be raised. Further, simulation models, including machine learning simulation models, can be trained and retrained with, for example, data regarding mission chunks not associated with disengagements so that the models over time can more accurately and consistently determine whether an event would have occurred had an autonomy system of an autonomous vehicle not been disengaged. In some examples, training the computer simulation model can be improved over time with “Pass”/“Fail” results to verify whether an evaluation provided by the model was accurate. In some examples, during a disengagement associated with a scenario, a probability of a collision may be output to verify whether an evaluation provided by a model was accurate. In some examples, a simulation may be repeated over and over with different state initializations. In some examples, a result may be returned as a sigmoid to improve the evaluation capabilities of a model. In contrast, training the human model may be improved over time with a playback of mission data and observed sensor data associated with the mission, which may beneficially induce a much more certain probability distribution relative to the training of the computer simulation model.

In FIG. 2, the evaluation utilization module 206 can be configured to utilize the hybrid evaluation framework described above in various applications. In some embodiments, the hybrid evaluation framework can be utilized in combination with various simulation platforms and classifiers. As an example, a simulation platform can simulate behavior of an autonomy system. The hybrid evaluation framework can be utilized in combination with the simulation platform to evaluate performance of the autonomy system by evaluating the behavior of the autonomy system in relation to mission chunks associated with disengagements. For example, mission chunks in which a first autonomy system of an autonomous vehicle is disengaged can be evaluated to determine whether a collision or a contact would have occurred had the autonomous vehicle not disengaged. The mission chunks can be provided to a simulation platform, and the simulation platform can simulate behavior of a second autonomy system in relation to the mission chunks. Performance of the second autonomy system can be evaluated based on the simulated behavior of the second autonomy system in relation to the mission chunks. For example, performance of the second autonomy system can be evaluated based on whether the second autonomy system disengaged and whether the second autonomy system would have caused a collision or a contact.

As another example, the hybrid evaluation framework can be utilized to determine an effectiveness of a particle classifier. In general, a particle classifier can determine whether a detected object is an external body or a phantom obstacle (e.g., cloud of dust). To determine an effectiveness of the particle classifier, mission chunks associated with a disengagement of an autonomy system of an autonomous vehicle can be evaluated to determine whether a collision or a contact would have occurred had the autonomy system of the autonomous vehicle not disengaged. For the mission chunks where it is determined that a collision or a contact would not have occurred, behavior of the autonomous vehicle can be evaluated to determine whether the disengagement is associated with a phantom obstacle. For example, a mission chunk associated with a disengagement can be evaluated to determine whether a collision or a contact would have occurred. Based on the evaluation and an analysis of braking behavior in relation to the mission chunk, then it can be determined whether the disengagement is associated with a phantom obstacle. In this example, the mission chunk associated with the disengagement can be utilized to determine an effectiveness of a particle classifier.

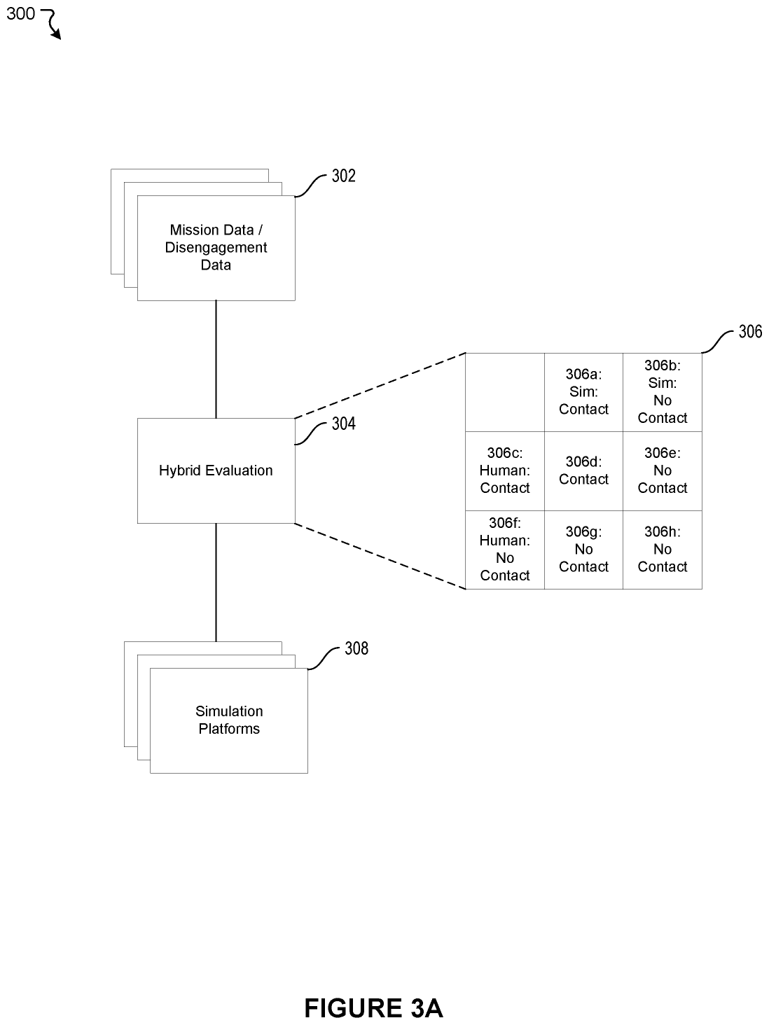

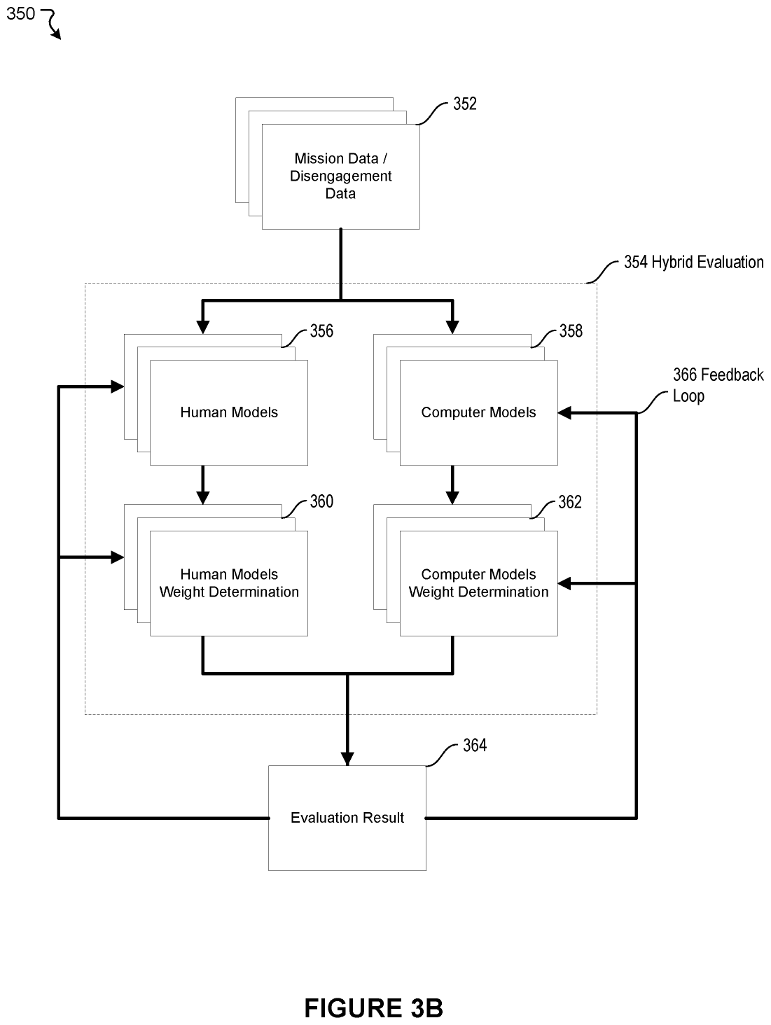

FIG. 3A illustrates an example application of an AV performance evaluation module, such as the AV performance evaluation module 202, according to an embodiment of the present technology. In an example scenario 300, mission data 302 is provided to a hybrid evaluation framework 304. The mission data 302 can be partitioned into mission chunks. Some of the mission chunks can be associated with a disengagement of an autonomy system of an autonomous vehicle and other mission chunks can be associated with no disengagement. The hybrid evaluation framework 304 can determine, for the mission chunks associated with a disengagement, whether a contact would have occurred if the autonomy system of the autonomous vehicle did not disengage. In this example, the hybrid evaluation framework 304 determines with a threshold level of confidence that a contact would have occurred based on a computer simulation model and a human model. Evaluation map 306 provides an example illustration of how the hybrid evaluation framework 304 determines contact. In the evaluation map 306, the computer simulation model can make a simulation contact determination 306a or a simulation no contact determination 306b. The human model can make a human contact determination 306c or a human no contact determination 306f. The hybrid evaluation framework 304, in this example, determines contact based on the computer simulation model and the human model. If the computer simulation model makes a simulation contact determination 306a and the human model makes a human contact determination 306c, then the hybrid evaluation framework 304 makes a contact determination 306d. If the computer simulation model makes a simulation no contact determination 306b and the human model makes a human contact determination 306c, then the hybrid evaluation framework 304 makes a no contact determination 306e. If the computer simulation model makes a simulation contact determination 306a and the human model makes a human no contact determination 306f, then the hybrid evaluation framework 304 makes a no contact determination 306g. If the computer simulation model makes a simulation no contact determination 306b and the human model makes a human no contact determination 306f, then the hybrid evaluation framework 304 makes a no contact determination 306h. The contact determinations and no contact determinations made by the hybrid evaluation framework 304 can be utilized by various simulation platforms 308 to evaluate, for example, effectiveness of different autonomy systems. In other embodiments, the hybrid evaluation framework 304 can be designed so that the contact outcomes in 306d, 306e, 306g, 306h are different from the outcomes shown. For example, if the computer simulation model makes a simulation no contact determination 306b and the human model makes a human contact determination 306c, then the hybrid evaluation framework 304 can make a contact determination. As another example, if the computer simulation model makes a simulation contact determination 306a and the human model makes a human no contact determination 306f, then the hybrid evaluation framework 304 can make a contact determination. Further, in some embodiments, weights can be applied to scores generated by the models used by the hybrid evaluation framework 304, as discussed herein. The weighted scores can be aggregated by the hybrid evaluation framework 304 to make a contact or no contact determination. Many variations are possible. It should be noted that the example scenario 300 may also utilize a percentage of probability of contact and a percentage of probability of no contact, respectively. In other words, while a binary evaluation may be utilized following disengagement from a scenario. A probability of contact and no contact may be utilized in association with any event (i.e., not limited to only a disengagement) such as distance from lane boundary, etc. In FIG. 2, the training module 208 can be configured to improve computer simulation models and human models based on feedback generated by a hybrid evaluation framework. As described herein, a hybrid evaluation framework can make a determination as to whether an event would occur based on weighted outputs from multiple models. The training module 208 can utilize the determination to provide feedback to the models. In some cases, the determination can be included in training data for training the models. For example, sensor data of a mission chunk that is determined by a hybrid evaluation framework to be associated with a contact can be utilized as training data that includes the sensor data and a label indicating that the contact would occur. In some cases, the determination can be used as feedback to adjust weights associated with the outputs of the models. The training module 208 can identify, based on a determination generated by a hybrid evaluation framework, models that produce false positives and/or false negatives and adjust weights associated with the models to discount outputs of the models when the models produce a positive and/or negative output. The models that produce outputs consistent with the determination generated by the hybrid evaluation framework can also have their weights increased to indicate greater reliance on the models. By utilizing output generated by a hybrid evaluation framework as feedback to models the hybrid evaluation framework relied on allows the models and the hybrid evaluation framework improve over time. According to some embodiments, simulation classification induces a probability distribution of pass/fail based on a presumed true and false positive rate from prior data to induce weightings. Accordingly, using the probability distribution from prior data for each type of scenario can refine the probability weighting for pass/fail to determine an amount of reliance on the computer simulation and human models. Additionally, in some embodiments, weight may be analogous to an embedding of data. For example, instead of relying merely upon pass/fail results to induce a probability distribution, it is possible to use the whole playback of the mission and sensor data associated with the mission, which induces a much more certain probability distribution for human models. In other words, for example, weighting of the models may be made possible through more certain probability distribution by supplementing with sensor data and whole playback of a mission to determine a more certain probability of contact and a probability of no contact instead of merely using a binary pass/fail result.

FIG. 3B illustrates an example feedback model for improving computer simulation models and human models with feedback. In an example scenario 350 mission data 352 is provided to a hybrid evaluation framework 354. The mission data 352 can include mission chunks associated with various scenarios encountered by an autonomy system of an autonomous vehicle. The hybrid evaluation framework 354 can include human models 356 and computer models 358. The human models 356 and the computer models 358 can evaluate the mission chunks and determine whether an event (e.g., a contact, a collision, etc.) would occur. The outputs from the human models 356 and the computer models 358 can be weighted by human models weight determination 360 and computer models weight determination 362. The weights determined by the human models weight determination 360 and the computer models weight determination 362 can indicate reliance on the human models 356 and the computer models 358 based on probability distributions using prior data. The hybrid evaluation framework 354 can generate an evaluation result 364 based on the weighted outputs of the human models 356 and the computer models 358. The evaluation result 364 can be utilized in a feedback loop 366 to further train or improve the human models 356 and the computer models 358. For example, based on the evaluation result 364, it can be determined that some of the human models 356 and some of the computer models 358 generated false positives or false negatives. These human models 356 and computer models 358 can be adjusted accordingly. Additionally, the human models weight determination 360 and the computer models weight determination 362 can be adjusted based on the evaluation result 364. For example, a computer model that generates a false positive according to the evaluation result 364 can be further trained based on the evaluation result 364 and a weight associated with the computer model can be lowered based on the evaluation result 364. Many variations are possible.

The data partition module 210 can be configured to partition sensor data associated with a mission into mission chunks. In general, a mission can involve an autonomous vehicle navigating a route in order to achieve a target objective. For example, a mission for an autonomous vehicle may have a target objective of collecting sensor data from a particular area. The autonomous vehicle may navigate to the particular area and navigate within the particular area until sufficient sensor data has been collected from the particular area and the target objective is achieved. As another example, a mission for an autonomous vehicle may have a target objective of encountering a certain scenario. The autonomous vehicle may navigate to a location where the scenario is likely to be encountered and, depending on whether the scenario was encountered, return to the location or navigate to a new location until the target objective is achieved.

As an autonomous vehicle navigates a route in the course of a mission, the autonomy system of an autonomous vehicle may undergo disengagements. In some embodiments, disengagements may include “planned” disengagements as well as “unplanned” disengagements. Planned disengagements may include disengagements that are expected based on the autonomous vehicle's operation design domain (ODD). In some implementations, the autonomous vehicle ODD can include three dimensions: (1) environment (e.g., night, day, raining, sunny, foggy, etc.); (2) static map elements (e.g., traffic signs, stop signs, lane markings, etc.); and (3) dynamic scenarios (e.g., lane changes, left or right turns, pedestrians, cyclists, etc.). For each of these dimensions, the autonomous vehicle ODD defines particular situations and/or scenarios that the autonomous vehicle is designed to handle. If the autonomous vehicle exceeds these particular situations and/or scenarios, then a driver may be expected to disengage the autonomy system of the autonomous vehicle. For example, an ODD of an autonomous vehicle may not be designed to drive outside of a particular geographic area. Under this example ODD, a driver of the autonomous vehicle may be expected to disengage the autonomous vehicle and take over operation of the autonomous vehicle once the autonomous vehicle leaves the geographic area. In contrast, unplanned disengagements may include any disengagements occurring in scenarios that an autonomous vehicle would be expected to handle under its ODD. In some cases, an unplanned disengagement may be a result of actions taken to avoid an event, such as a collision. For example, a driver of an autonomous vehicle may believe that a collision is about to occur and accordingly disengage the autonomy system of the autonomous vehicle to assume manual control over operation of the autonomous vehicle. In this example, in order to accurately and consistently evaluate the performance of the autonomous vehicle, it would be advantageous to determine whether the collision was likely to have occurred had the driver not disengaged the autonomy system of the autonomous vehicle.

In the course of a mission, sensors on an autonomous vehicle collect sensor data associated with the mission. Sensor data can include, for example, image data, video data, LiDAR data, radar data, GPS data, etc. The data partition module 210 can be configured to partition a mission, and the sensor data associated with the mission, into multiple mission chunks. The mission can be partitioned, for example, by time, distance, road segment type, or other factors. For example, a mission can be partitioned into ten second mission chunks. As another example, a mission can be partitioned into 500 feet mission chunks. In some cases, a mission chunk can be associated with a disengagement of an autonomy system of an autonomous vehicle and sensor data collected by sensors prior to and/or after the disengagement. The sensor data relating to a mission chunk associated with the disengagement can be evaluated to determine a likelihood that an event, such as a contact or a collision, would have occurred.

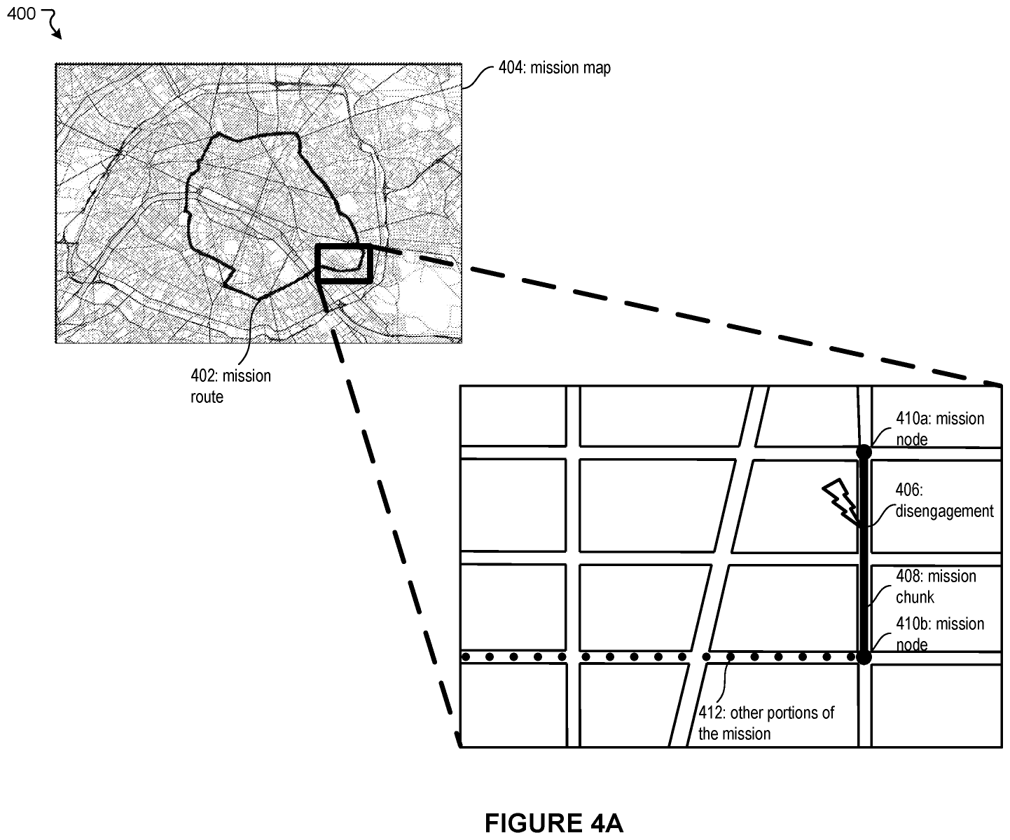

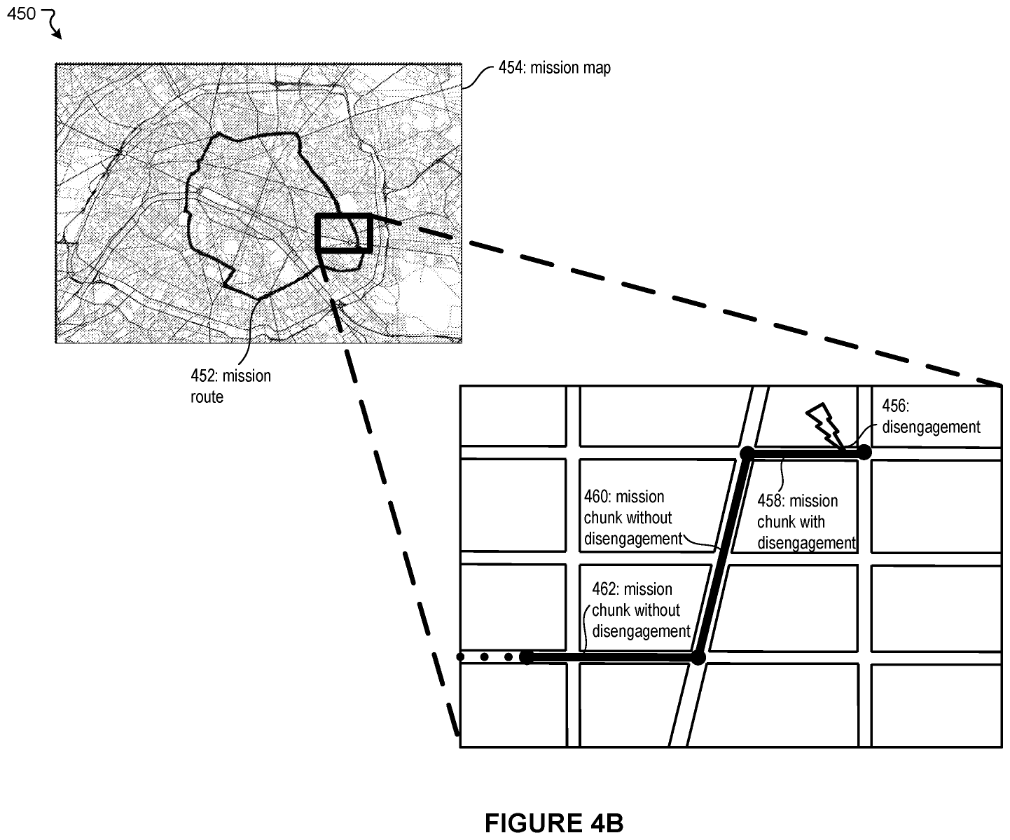

FIGS. 4A and 4B illustrate example scenarios which relate to partitioning of a mission into mission chunks, according to an embodiment of the present technology. In FIG. 4A, in an example scenario 400, an autonomous vehicle may travel a mission route 402 in the course of a mission. The mission route 402, as indicated on a mission map 404, may be significantly lengthy and traverse through a variety of different environmental conditions. Sensor data can be collected from sensors as the autonomous vehicle executes the mission. In the course of the mission, an autonomy system of the autonomous vehicle may experience a disengagement 406. A mission chunk 408 associated with the disengagement 406 can be partitioned from the mission. The mission chunk 408 can be, for example, a ten second mission chunk that is associated with sensor data collected by sensors before and after the disengagement 406. In this example, mission nodes 410a, 410b establish reference points that separate the mission chunk 408 from other portions of the mission 412. The mission chunk 408 can be evaluated based on the sensor data associated with the mission chunk 408. Based on the evaluation of the sensor data associated with the mission chunk 408, it can be determined whether an event, such as a collision or a contact, would have occurred had the autonomy system of the autonomous vehicle not disengaged. In this example, the evaluation of the mission chunk 408 may involve simulating the mission chunk 408 based on the associated sensor data. In some cases, simulating a mission may introduce noise or error such that the exact conditions of the mission are not fully and accurately simulated. If a significantly lengthy mission is simulated in its entirety, then the increased noise or error may aggregate and result in increased inaccuracies in the simulation. In contrast, partitioning the mission into mission chunks and evaluating the mission chunks alone prevents the noise and error from aggregating. Thus, as demonstrated in the example scenario 400, partitioning the mission into mission chunks, such as the mission chunk 408, and evaluating the mission chunks alone minimizes noise and error to produce a more accurate and reliable simulation.

Additionally, partitioning the mission into mission chunks allows for improved evaluation in cases where modularity of an autonomy system is being evaluated. In some cases, an autonomy system includes multiple modules that may be updated over time. When one or more of the modules of the autonomy system are updated, performance of the autonomy system can be evaluated and reevaluated with the same mission chunks or different mission chunks to determine whether the updates to the one or more modules generate different results. Based on whether the updates generate different results, the updates can be evaluated to determine whether they were effective. For example, performance of an autonomy system may be evaluated by simulating what the autonomy system does when provided with sensor data associated with a mission chunk. A module of the autonomy system may be updated from a first version to a second version and the performance of the autonomy system may be reevaluated. If the autonomy system performs better with the second version of the module than the first version of the module when provided with the sensor data associated with the mission chunk, then it can be determined that the update to the module was effective at improving the autonomy system. Additionally, partitioning the mission into mission chunks can provide an aspect of data augmentation. For example, simulating a first chunk (e.g., time frame of 5-10 seconds of the mission) and a second chunk (e.g., time frame of 8-13 seconds of the mission) can yield diverse results even though there is a three second overlap between the first and second chunks.

In FIG. 4B, in an example scenario 450, an autonomous vehicle may travel a mission route 452 in the course of a mission. Similar to the mission route 402 of example scenario 400 in FIG. 4A, the mission route 452, as indicated on a mission map 454, may be significantly long and traverse through a variety of different environmental conditions. In the course of the mission, an autonomy system of the autonomous vehicle may experience a disengagement 456. Similar to example scenario 400 in FIG. 4A, a mission chunk 458 associated with the disengagement 356 can be partitioned from the mission. The mission chunk 458 can be evaluated based on sensor data associated with the mission chunk 458 and, based on the evaluation, it can be determined whether an event would have occurred. In the example scenario 450, mission chunks 460, 463 are also partitioned from the mission. The mission chunks 460, 462 are not associated with a disengagement, but nonetheless the mission chunks 460, 462 can also be evaluated to determine whether an event would have occurred. In this example, the evaluations of mission chunks 460, 462 can be used to validate the accuracy of an evaluation framework that made the evaluation of mission chunk 458. For example, the evaluation of mission chunk 460 and the evaluation of mission chunk 462 by the evaluation framework may both result in a determination that an event would not have occurred. This would indicate that the evaluation of mission chunk 458 by the evaluation framework is likely to be accurate. In this example, the mission chunks 458, 460, 462 were evaluated to determine whether an event would have occurred. In some embodiments, the mission chunks 458, 460, 462 can be evaluated to determine events with greater granularity. For example, the mission chunks 458, 460, 462 can be evaluated to determine whether a front end collision would have occurred or whether a rear end collision would have occurred. In some embodiments, the entire mission can be partitioned into mission chunks and each mission chunk can be independently evaluated by an evaluation framework to determine whether an event would have occurred. If evaluations by the evaluation framework of each mission chunk not associated with a disengagement consistently result in a determination that an event would not have occurred, then it can be determined that evaluations by the evaluation framework of mission chunks associated with a disengagement are likely to be accurate. Thus, as demonstrated in the example scenario 450, partitioning the mission chunks 458, 460, 462 from the mission and evaluating the mission chunks 458, 460, 462 can produce more accurate and more consistent evaluations.

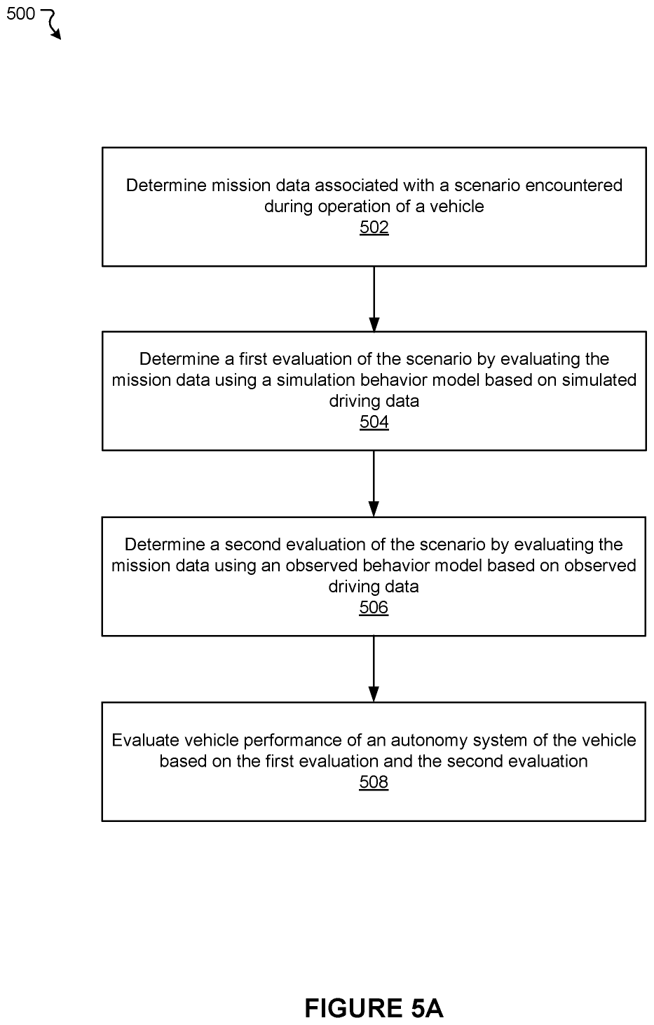

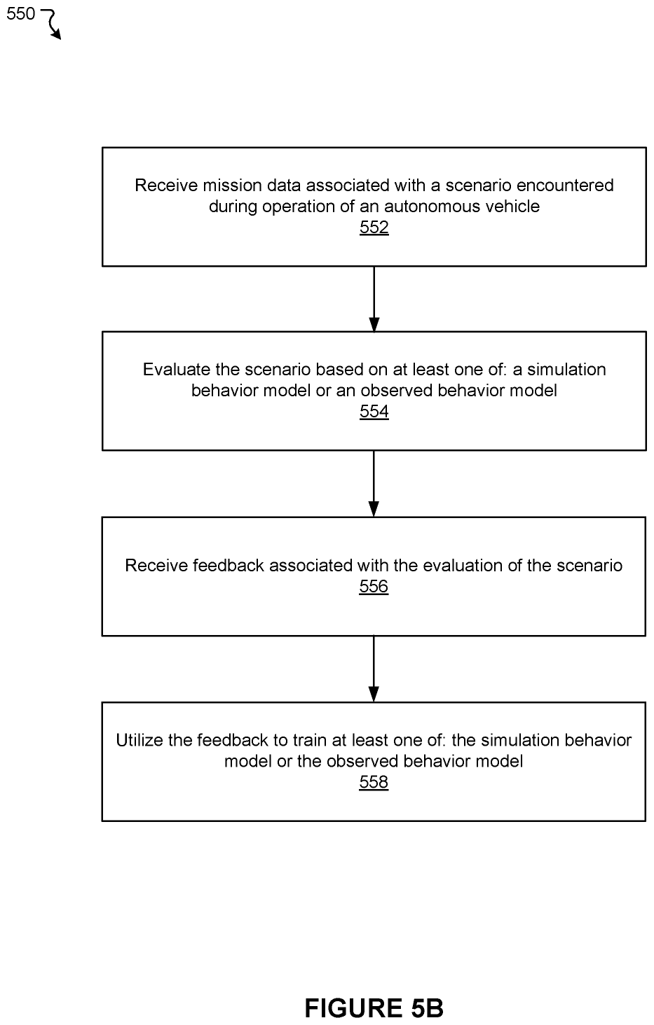

FIG. 5A illustrates an example method 500, according to an embodiment of the present technology. At block 502, the example method 500 can determine mission data associated with a scenario encountered during operation of an autonomous vehicle. At block 504, the example method 500 can determine a first evaluation of the scenario by evaluating the mission data using a simulation behavior model based on simulated driving data. At block 506, the example method 500 can determine a second evaluation of the scenario by evaluating the mission data using an observed behavior model based on observed driving data. At block 508, the example method 500 can evaluate vehicle performance of an autonomy system of the vehicle based on the first evaluation and the second evaluation.

Many variations to the example method are possible. It should be appreciated that there can be additional, fewer, or alternative steps performed in similar or alternative orders, or in parallel, within the scope of the various embodiments discussed herein unless otherwise stated.

FIG. 5B illustrates an example method 550, according to an embodiment of the present technology. At block 552, the example method 550 can receive mission data associated with a scenario encountered during operation of an autonomous vehicle. At block 554, the example method 550 can evaluate the scenario based on at least one of: a simulation behavior model or an observed behavior model. In some examples, the scenario is evaluated based on a weight associated with the simulation behavior model (e.g., computer simulation model) and a weight associated with the observed behavior model (e.g., human simulation model). At block 556, the example method 550 can receive feedback associated with the evaluation of the scenario. At block 558, the example method 550 can utilize the feedback to train at least one of the simulation behavior model or the observed behavior model to become more adept at evaluating the scenario.

Many variations to the example method are possible. It should be appreciated that there can be additional, fewer, or alternative steps performed in similar or alternative orders, or in parallel, within the scope of the various embodiments discussed herein unless otherwise stated.

FIG. 6 illustrates an example block diagram of a transportation management environment for matching ride requestors with vehicles. In particular embodiments, the environment may include various computing entities, such as a user computing device 630 of a user 601 (e.g., a ride provider or requestor), a transportation management system 660, a vehicle 640, and one or more third-party systems 670. The vehicle 640 can be autonomous, semi-autonomous, or manually drivable. The computing entities may be communicatively connected over any suitable network 610. As an example and not by way of limitation, one or more portions of network 610 may include an ad hoc network, an extranet, a virtual private network (VPN), a local area network (LAN), a wireless LAN (WLAN), a wide area network (WAN), a wireless WAN (WWAN), a metropolitan area network (MAN), a portion of the Internet, a portion of Public Switched Telephone Network (PSTN), a cellular network, or a combination of any of the above. In particular embodiments, any suitable network arrangement and protocol enabling the computing entities to communicate with each other may be used. Although FIG. 6 illustrates a single user device 630, a single transportation management system 660, a single vehicle 640, a plurality of third-party systems 670, and a single network 610, this disclosure contemplates any suitable number of each of these entities. As an example and not by way of limitation, the network environment may include multiple users 601, user devices 630, transportation management systems 660, vehicles 640, third-party systems 670, and networks 610. In some embodiments, some or all modules shown in FIG. 2 may be implemented by one or more computing systems of the transportation management system 660. In some embodiments, some or all modules shown in FIG. 2 may be implemented by one or more computing systems in the vehicle 640. In some embodiments, some or all modules shown in FIG. 2 may be implemented by the user device 630.

The user device 630, transportation management system 660, vehicle 640, and third-party system 670 may be communicatively connected or co-located with each other in whole or in part. These computing entities may communicate via different transmission technologies and network types. For example, the user device 630 and the vehicle 640 may communicate with each other via a cable or short-range wireless communication (e.g., Bluetooth, NFC, WI-FI, etc.), and together they may be connected to the Internet via a cellular network that is accessible to either one of the devices (e.g., the user device 630 may be a smartphone with LTE connection). The transportation management system 660 and third-party system 670, on the other hand, may be connected to the Internet via their respective LAN/WLAN networks and Internet Service Providers (ISP). FIG. 6 illustrates transmission links 650 that connect user device 630, vehicle 640, transportation management system 660, and third-party system 670 to communication network 610. This disclosure contemplates any suitable transmission links 650, including, e.g., wire connections (e.g., USB, Lightning, Digital Subscriber Line (DSL) or Data Over Cable Service Interface Specification (DOCSIS)), wireless connections (e.g., WI-FI, WiMAX, cellular, satellite, NFC, Bluetooth), optical connections (e.g., Synchronous Optical Networking (SONET), Synchronous Digital Hierarchy (SDH)), any other wireless communication technologies, and any combination thereof. In particular embodiments, one or more links 650 may connect to one or more networks 610, which may include in part, e.g., ad-hoc network, the Intranet, extranet, VPN, LAN, WLAN, WAN, WWAN, MAN, PSTN, a cellular network, a satellite network, or any combination thereof. The computing entities need not necessarily use the same type of transmission link 650. For example, the user device 630 may communicate with the transportation management system via a cellular network and the Internet, but communicate with the vehicle 640 via Bluetooth or a physical wire connection.

In particular embodiments, the transportation management system 660 may fulfill ride requests for one or more users 601 by dispatching suitable vehicles. The transportation management system 660 may receive any number of ride requests from any number of ride requestors 601. In particular embodiments, a ride request from a ride requestor 601 may include an identifier that identifies the ride requestor in the system 660. The transportation management system 660 may use the identifier to access and store the ride requestor's 601 information, in accordance with the requestor's 601 privacy settings. The ride requestor's 601 information may be stored in one or more data stores (e.g., a relational database system) associated with and accessible to the transportation management system 660. In particular embodiments, ride requestor information may include profile information about a particular ride requestor 601. In particular embodiments, the ride requestor 601 may be associated with one or more categories or types, through which the ride requestor 601 may be associated with aggregate information about certain ride requestors of those categories or types. Ride information may include, for example, preferred pick-up and drop-off locations, driving preferences (e.g., safety comfort level, preferred speed, rates of acceleration/deceleration, safety distance from other vehicles when travelling at various speeds, route, etc.), entertainment preferences and settings (e.g., preferred music genre or playlist, audio volume, display brightness, etc.), temperature settings, whether conversation with the driver is welcomed, frequent destinations, historical riding patterns (e.g., time of day of travel, starting and ending locations, etc.), preferred language, age, gender, or any other suitable information. In particular embodiments, the transportation management system 660 may classify a user 601 based on known information about the user 601 (e.g., using machine-learning classifiers), and use the classification to retrieve relevant aggregate information associated with that class. For example, the system 660 may classify a user 601 as a young adult and retrieve relevant aggregate information associated with young adults, such as the type of music generally preferred by young adults.

Transportation management system 660 may also store and access ride information. Ride information may include locations related to the ride, traffic data, route options, optimal pick-up or drop-off locations for the ride, or any other suitable information associated with a ride. As an example and not by way of limitation, when the transportation management system 660 receives a request to travel from San Francisco International Airport (SFO) to Palo Alto, Calif., the system 660 may access or generate any relevant ride information for this particular ride request. The ride information may include, for example, preferred pick-up locations at SFO; alternate pick-up locations in the event that a pick-up location is incompatible with the ride requestor (e.g., the ride requestor may be disabled and cannot access the pick-up location) or the pick-up location is otherwise unavailable due to construction, traffic congestion, changes in pick-up/drop-off rules, or any other reason; one or more routes to navigate from SFO to Palo Alto; preferred off-ramps for a type of user; or any other suitable information associated with the ride. In particular embodiments, portions of the ride information may be based on historical data associated with historical rides facilitated by the system 660. For example, historical data may include aggregate information generated based on past ride information, which may include any ride information described herein and telemetry data collected by sensors in vehicles and user devices. Historical data may be associated with a particular user (e.g., that particular user's preferences, common routes, etc.), a category/class of users (e.g., based on demographics), and all users of the system 660. For example, historical data specific to a single user may include information about past rides that particular user has taken, including the locations at which the user is picked up and dropped off, music the user likes to listen to, traffic information associated with the rides, time of the day the user most often rides, and any other suitable information specific to the user. As another example, historical data associated with a category/class of users may include, e.g., common or popular ride preferences of users in that category/class, such as teenagers preferring pop music, ride requestors who frequently commute to the financial district may prefer to listen to the news, etc. As yet another example, historical data associated with all users may include general usage trends, such as traffic and ride patterns. Using historical data, the system 660 in particular embodiments may predict and provide ride suggestions in response to a ride request. In particular embodiments, the system 660 may use machine-learning, such as neural networks, regression algorithms, instance-based algorithms (e.g., k-Nearest Neighbor), decision-tree algorithms, Bayesian algorithms, clustering algorithms, association-rule-learning algorithms, deep-learning algorithms, dimensionality-reduction algorithms, ensemble algorithms, and any other suitable machine-learning algorithms known to persons of ordinary skill in the art. The machine-learning models may be trained using any suitable training algorithm, including supervised learning based on labeled training data, unsupervised learning based on unlabeled training data, and semi-supervised learning based on a mixture of labeled and unlabeled training data.

In particular embodiments, transportation management system 660 may include one or more server computers. Each server may be a unitary server or a distributed server spanning multiple computers or multiple datacenters. The servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by the server. In particular embodiments, transportation management system 660 may include one or more data stores. The data stores may be used to store various types of information, such as ride information, ride requestor information, ride provider information, historical information, third-party information, or any other suitable type of information. In particular embodiments, the information stored in the data stores may be organized according to specific data structures. In particular embodiments, each data store may be a relational, columnar, correlation, or any other suitable type of database system. Although this disclosure describes or illustrates particular types of databases, this disclosure contemplates any suitable types of databases. Particular embodiments may provide interfaces that enable a user device 630 (which may belong to a ride requestor or provider), a transportation management system 660, vehicle system 640, or a third-party system 670 to process, transform, manage, retrieve, modify, add, or delete the information stored in the data store.

In particular embodiments, transportation management system 660 may include an authorization server (or any other suitable component(s)) that allows users 601 to opt-in to or opt-out of having their information and actions logged, recorded, or sensed by transportation management system 660 or shared with other systems (e.g., third-party systems 670). In particular embodiments, a user 601 may opt-in or opt-out by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users 601 of transportation management system 660 through blocking, data hashing, anonymization, or other suitable techniques as appropriate.

In particular embodiments, third-party system 670 may be a network-addressable computing system that may provide HD maps or host GPS maps, customer reviews, music or content, weather information, or any other suitable type of information. Third-party system 670 may generate, store, receive, and send relevant data, such as, for example, map data, customer review data from a customer review website, weather data, or any other suitable type of data. Third-party system 670 may be accessed by the other computing entities of the network environment either directly or via network 610. For example, user device 630 may access the third-party system 670 via network 610, or via transportation management system 660. In the latter case, if credentials are required to access the third-party system 670, the user 601 may provide such information to the transportation management system 660, which may serve as a proxy for accessing content from the third-party system 670.

In particular embodiments, user device 630 may be a mobile computing device such as a smartphone, tablet computer, or laptop computer. User device 630 may include one or more processors (e.g., CPU, GPU), memory, and storage. An operating system and applications may be installed on the user device 630, such as, e.g., a transportation application associated with the transportation management system 660, applications associated with third-party systems 670, and applications associated with the operating system. User device 630 may include functionality for determining its location, direction, or orientation, based on integrated sensors such as GPS, compass, gyroscope, or accelerometer. User device 630 may also include wireless transceivers for wireless communication and may support wireless communication protocols such as Bluetooth, near-field communication (NFC), infrared (IR) communication, WI-FI, and 2G/3G/4G/LTE mobile communication standard. User device 630 may also include one or more cameras, scanners, touchscreens, microphones, speakers, and any other suitable input-output devices.

In particular embodiments, the vehicle 640 may be equipped with an array of sensors 644, a navigation system 646, and a ride-service computing device 648. In particular embodiments, a fleet of vehicles 640 may be managed by the transportation management system 660. The fleet of vehicles 640, in whole or in part, may be owned by the entity associated with the transportation management system 660, or they may be owned by a third-party entity relative to the transportation management system 660. In either case, the transportation management system 660 may control the operations of the vehicles 640, including, e.g., dispatching select vehicles 640 to fulfill ride requests, instructing the vehicles 640 to perform select operations (e.g., head to a service center or charging/fueling station, pull over, stop immediately, self-diagnose, lock/unlock compartments, change music station, change temperature, and any other suitable operations), and instructing the vehicles 640 to enter select operation modes (e.g., operate normally, drive at a reduced speed, drive under the command of human operators, and any other suitable operational modes).

In particular embodiments, the vehicles 640 may receive data from and transmit data to the transportation management system 660 and the third-party system 670. Examples of received data may include, e.g., instructions, new software or software updates, maps, 3D models, trained or untrained machine-learning models, location information (e.g., location of the ride requestor, the vehicle 640 itself, other vehicles 640, and target destinations such as service centers), navigation information, traffic information, weather information, entertainment content (e.g., music, video, and news) ride requestor information, ride information, and any other suitable information. Examples of data transmitted from the vehicle 640 may include, e.g., telemetry and sensor data, determinations/decisions based on such data, vehicle condition or state (e.g., battery/fuel level, tire and brake conditions, sensor condition, speed, odometer, etc.), location, navigation data, passenger inputs (e.g., through a user interface in the vehicle 640, passengers may send/receive data to the transportation management system 660 and third-party system 670), and any other suitable data.

In particular embodiments, vehicles 640 may also communicate with each other, including those managed and not managed by the transportation management system 660. For example, one vehicle 640 may communicate with another vehicle data regarding their respective location, condition, status, sensor reading, and any other suitable information. In particular embodiments, vehicle-to-vehicle communication may take place over direct short-range wireless connection (e.g., WI-FI, Bluetooth, NFC) or over a network (e.g., the Internet or via the transportation management system 660 or third-party system 670), or both.

In particular embodiments, a vehicle 640 may obtain and process sensor/telemetry data. Such data may be captured by any suitable sensors. For example, the vehicle 640 may have a Light Detection and Ranging (LiDAR) sensor array of multiple LiDAR transceivers that are configured to rotate 360°, emitting pulsed laser light and measuring the reflected light from objects surrounding vehicle 640. In particular embodiments, LiDAR transmitting signals may be steered by use of a gated light valve, which may be a MEMs device that directs a light beam using the principle of light diffraction. Such a device may not use a gimbaled mirror to steer light beams in 360° around the vehicle. Rather, the gated light valve may direct the light beam into one of several optical fibers, which may be arranged such that the light beam may be directed to many discrete positions around the vehicle. Thus, data may be captured in 360° around the vehicle, but no rotating parts may be necessary. A LiDAR is an effective sensor for measuring distances to targets, and as such may be used to generate a three-dimensional (3D) model of the external environment of the vehicle 640. As an example and not by way of limitation, the 3D model may represent the external environment including objects such as other cars, curbs, debris, objects, and pedestrians up to a maximum range of the sensor arrangement (e.g., 50, 100, or 200 meters). As another example, the vehicle 640 may have optical cameras pointing in different directions. The cameras may be used for, e.g., recognizing roads, lane markings, street signs, traffic lights, police, other vehicles, and any other visible objects of interest. To enable the vehicle 640 to “see” at night, infrared cameras may be installed. In particular embodiments, the vehicle may be equipped with stereo vision for, e.g., spotting hazards such as pedestrians or tree branches on the road. As another example, the vehicle 640 may have radars for, e.g., detecting other vehicles and hazards afar. Furthermore, the vehicle 640 may have ultrasound equipment for, e.g., parking and obstacle detection. In addition to sensors enabling the vehicle 640 to detect, measure, and understand the external world around it, the vehicle 640 may further be equipped with sensors for detecting and self-diagnosing the vehicle's own state and condition. For example, the vehicle 640 may have wheel sensors for, e.g., measuring velocity; global positioning system (GPS) for, e.g., determining the vehicle's current geolocation; and inertial measurement units, accelerometers, gyroscopes, and odometer systems for movement or motion detection. While the description of these sensors provides particular examples of utility, one of ordinary skill in the art would appreciate that the utilities of the sensors are not limited to those examples. Further, while an example of a utility may be described with respect to a particular type of sensor, it should be appreciated that the utility may be achieved using any combination of sensors. For example, the vehicle 640 may build a 3D model of its surrounding based on data from its LiDAR, radar, sonar, and cameras, along with a pre-generated map obtained from the transportation management system 660 or the third-party system 670. Although sensors 644 appear in a particular location on the vehicle 640 in FIG. 6, sensors 644 may be located in any suitable location in or on the vehicle 640. Example locations for sensors include the front and rear bumpers, the doors, the front windshield, on the side panel, or any other suitable location.

In particular embodiments, the vehicle 640 may be equipped with a processing unit (e.g., one or more CPUs and GPUs), memory, and storage. The vehicle 640 may thus be equipped to perform a variety of computational and processing tasks, including processing the sensor data, extracting useful information, and operating accordingly. For example, based on images captured by its cameras and a machine-vision model, the vehicle 640 may identify particular types of objects captured by the images, such as pedestrians, other vehicles, lanes, curbs, and any other objects of interest.

In particular embodiments, the vehicle 640 may have a navigation system 646 responsible for safely navigating the vehicle 640. In particular embodiments, the navigation system 646 may take as input any type of sensor data from, e.g., a Global Positioning System (GPS) module, inertial measurement unit (IMU), LiDAR sensors, optical cameras, radio frequency (RF) transceivers, or any other suitable telemetry or sensory mechanisms. The navigation system 646 may also utilize, e.g., map data, traffic data, accident reports, weather reports, instructions, target destinations, and any other suitable information to determine navigation routes and particular driving operations (e.g., slowing down, speeding up, stopping, swerving, etc.). In particular embodiments, the navigation system 646 may use its determinations to control the vehicle 640 to operate in prescribed manners and to guide the vehicle 640 to its destinations without colliding into other objects. Although the physical embodiment of the navigation system 646 (e.g., the processing unit) appears in a particular location on the vehicle 640 in FIG. 6, navigation system 646 may be located in any suitable location in or on the vehicle 640. Example locations for navigation system 646 include inside the cabin or passenger compartment of the vehicle 640, near the engine/battery, near the front seats, rear seats, or in any other suitable location.

In particular embodiments, the vehicle 640 may be equipped with a ride-service computing device 648, which may be a tablet or any other suitable device installed by transportation management system 660 to allow the user to interact with the vehicle 640, transportation management system 660, other users 601, or third-party systems 670. In particular embodiments, installation of ride-service computing device 648 may be accomplished by placing the ride-service computing device 648 inside the vehicle 640, and configuring it to communicate with the vehicle 640 via a wired or wireless connection (e.g., via Bluetooth). Although FIG. 6 illustrates a single ride-service computing device 648 at a particular location in the vehicle 640, the vehicle 640 may include several ride-service computing devices 648 in several different locations within the vehicle. As an example and not by way of limitation, the vehicle 640 may include four ride-service computing devices 648 located in the following places: one in front of the front-left passenger seat (e.g., driver's seat in traditional U.S. automobiles), one in front of the front-right passenger seat, one in front of each of the rear-left and rear-right passenger seats. In particular embodiments, ride-service computing device 648 may be detachable from any component of the vehicle 640. This may allow users to handle ride-service computing device 648 in a manner consistent with other tablet computing devices. As an example and not by way of limitation, a user may move ride-service computing device 648 to any location in the cabin or passenger compartment of the vehicle 640, may hold ride-service computing device 648, or handle ride-service computing device 648 in any other suitable manner. Although this disclosure describes providing a particular computing device in a particular manner, this disclosure contemplates providing any suitable computing device in any suitable manner.

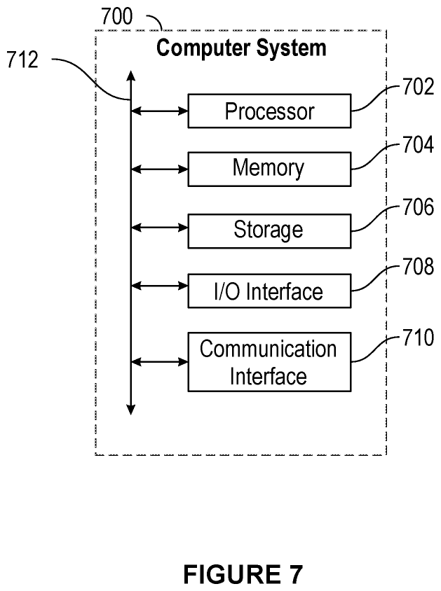

FIG. 7 illustrates an example computer system 700. In particular embodiments, one or more computer systems 700 perform one or more steps of one or more methods described or illustrated herein. In particular embodiments, one or more computer systems 700 provide the functionalities described or illustrated herein. In particular embodiments, software running on one or more computer systems 700 performs one or more steps of one or more methods described or illustrated herein or provides the functionalities described or illustrated herein. Particular embodiments include one or more portions of one or more computer systems 700. Herein, a reference to a computer system may encompass a computing device, and vice versa, where appropriate. Moreover, a reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 that are to be operated on by computer instructions; the results of previous instructions executed by processor 702 that are accessible to subsequent instructions or for writing to memory 704 or storage 706; or any other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs), be a multi-core processor, or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described in further detail below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware or software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware or software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or any other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a Bluetooth WPAN), a WI-FI network, a WI-MAX network, a cellular telephone network (such as, for example, a Global System for Mobile Communications (GSM) network), or any other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware or software, or both coupling components of computer system 700 to each other. As an example and not by way of limitation, bus 712 may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A or B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Methods described herein may vary in accordance with the present disclosure. Various embodiments of this disclosure may repeat one or more steps of the methods described herein, where appropriate. Although this disclosure describes and illustrates particular steps of certain methods as occurring in a particular order, this disclosure contemplates any suitable steps of the methods occurring in any suitable order or in any combination which may include all, some, or none of the steps of the methods. Furthermore, although this disclosure may describe and illustrate particular components, devices, or systems carrying out particular steps of a method, this disclosure contemplates any suitable combination of any suitable components, devices, or systems carrying out any suitable steps of the method.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, modules, elements, feature, functions, operations, or steps, any of these embodiments may include any combination or permutation of any of the components, modules, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A computer-implemented method comprising:
determining, by a computing system, mission data associated with a scenario encountered during operation of a vehicle;
determining, by the computing system, a first evaluation of the scenario by evaluating the mission data using a simulation behavior model based on simulated driving data;
determining, by the computing system, a second evaluation of the scenario by evaluating the mission data using an observed behavior model based on observed driving data; and
evaluating, by the computing system, vehicle performance of an autonomy system of the vehicle based on the first evaluation and the second evaluation.

2. The computer-implemented method of claim 1, wherein the first evaluation is associated with a first weight and the second evaluation is associated with a second weight and wherein the evaluating is further based on the first weight applied to the first evaluation and the second weight applied to the second evaluation.

3. The computer-implemented method of claim 2, wherein the first weight indicates a first reliance associated with the simulation behavior model for a type of evaluation being performed by the simulation behavior model and the second weight indicates a second reliance associated with the observed behavior model for the type of evaluation being performed by the observed behavior model.

4. The computer-implemented method of claim 2, wherein the first weight is based on a plurality of evaluations by the simulation behavior model based on other mission data different from the mission data associated with the scenario and the second weight is based on a plurality of evaluations by the observed behavior model based on the other mission data.

5. The computer-implemented method of claim 1, further comprising identifying a false positive or a false negative associated with at least one of: the first evaluation or the second evaluation.

6. The computer-implemented method of claim 1, further comprising partitioning the mission data into a plurality of mission chunks.

7. The computer-implemented method of claim 1, wherein at least one of the simulation behavior model or the observed behavior model applies at least one of: a rule based assumption or a model based assumption.

8. The computer-implemented method of claim 1, wherein at least one of the first evaluation or the second evaluation includes a determination of a predicted contact between the vehicle and an object associated with the scenario.

9. The computer-implemented method of claim 1, wherein the evaluating the autonomous vehicle performance of the autonomy system comprises determining a performance metric that includes at least one of: miles per estimated contact (MPEC) or miles per intervention (MPI).

10. The computer-implemented method of claim 1, wherein the mission data is collected by sensors on the autonomous vehicle and the mission data includes at least one of: image data, video data, light detection and ranging (LiDAR) data, radar data, or global positioning system (GPS) data.

11. A system comprising:
at least one processor; and
a memory storing instructions that, when executed by the at least one processor, cause the system to perform:
determining mission data associated with a scenario encountered during operation of a vehicle;
determining a first evaluation of the scenario by evaluating the mission data using a simulation behavior model based on simulated driving data;
determining a second evaluation of the scenario by evaluating the mission data using an observed behavior model based on observed driving data; and
evaluating vehicle performance of an autonomy system of the vehicle based on the first evaluation and the second evaluation.

12. The system of claim 11, wherein the first evaluation is associated with a first weight and the second evaluation is associated with a second weight and wherein the evaluating is further based on the first weight applied to the first evaluation and the second weight applied to the second evaluation.

13. The system of claim 12, wherein the first weight indicates a first reliance associated with the simulation behavior model for a type of evaluation being performed by the simulation behavior model and the second weight indicates a second reliance associated with the observed behavior model for the type of evaluation being performed by the observed behavior model.

14. The system of claim 12, wherein the first weight is based on a plurality of evaluations by the simulation behavior model based on other mission data different from the mission data associated with the scenario and the second weight is based on a plurality of evaluations by the observed behavior model based on the other mission data.

15. The system of claim 11, further comprising identifying a false positive or a false negative associated with at least one of: the first evaluation or the second evaluation.

16. A non-transitory computer-readable storage medium including instructions that, when executed by at least one processor of a computing system, cause the computing system to perform a method comprising:
determining mission data associated with a scenario encountered during operation of a vehicle;
determining a first evaluation of the scenario by evaluating the mission data using a simulation behavior model based on simulated driving data;
determining a second evaluation of the scenario by evaluating the mission data using an observed behavior model based on observed driving data; and
evaluating vehicle performance of an autonomy system of the vehicle based on the first evaluation and the second evaluation.

17. The non-transitory computer-readable storage medium of claim 16, wherein the first evaluation is associated with a first weight and the second evaluation is associated with a second weight and wherein the evaluating is further based on the first weight applied to the first evaluation and the second weight applied to the second evaluation.

18. The non-transitory computer-readable storage medium of claim 17, wherein the first weight indicates a first reliance associated with the simulation behavior model for a type of evaluation being performed by the simulation behavior model and the second weight indicates a second reliance associated with the observed behavior model for the type of evaluation being performed by the observed behavior model.

19. The non-transitory computer-readable storage medium of claim 17, wherein the first weight is based on a plurality of evaluations by the simulation behavior model based on other mission data different from the mission data associated with the scenario and the second weight is based on a plurality of evaluations by the observed behavior model based on the other mission data.

20. The non-transitory computer-readable storage medium of claim 16, further comprising identifying a false positive or a false negative associated with at least one of: the first evaluation or the second evaluation.
